(19) United States
(12) Patent Application Publication
(10) Pub. No.: US 2023/0236127 A1
(43) Pub. Date: Jul. 27, 2023

(54) APPARATUS FOR DETERMINING THE PRESENCE OR CONCENTRATION OF TARGET MOLECULES

(71) Applicant: ams International AG, JONA (CH)

(72) Inventors: Remco VERDOOLD, Geldrop (NL); Erik Jan LOUS, Veldhoven (NL)

(73) Assignee: ams International AG, JONA (CH)

(21) Appl. No.: 18/012,140

(22) PCT Filed: Jun. 30, 2021
(86) PCT No.: PCT/EP2021/067977

§ 371 Date: Dec. 21, 2022

(30) Foreign Application Priority Data
Jun. 30, 2020 (GB) 2010028.5

(51) Int. Cl. G01N 21/552

(52) U.S. Cl. CPC G01N 21/554; G01N 2201/062; G01N 2201/0636; G01N 2201/0634

(57) ABSTRACT

An apparatus for determining the presence or concentration of target molecules comprises: a radiation source; a surface; a waveguide; a detector; and a spectral filter. The radiation source is operable to produce electromagnetic radiation. The surface defines a two dimensional array of receptor sites. The waveguide is arranged to receive the electromagnetic radiation produced by the radiation source, divide the electromagnetic radiation and direct a portion of the electromagnetic radiation to each one of a two dimensional array of receptor sites. The detector comprises a two dimensional array of sensing elements, each sensing element arranged to receive electromagnetic radiation from a different one of the two dimensional array of receptor sites. The spectral filter is provided between the surface and the detector.

### TECHNICAL FIELD OF THE DISCLOSURE

This disclosure relates to an apparatus for determining the presence or concentration of target molecules. The apparatus may have application, for example, in an assay (also sometimes referred to as a molecular interaction assay), which is arranged to measure the presence or concentration of a specific target molecule.

### BACKGROUND OF THE DISCLOSURE

There are known techniques that are able to report or visualize the specific interaction between biomolecules. Such a technique or test may be referred to as a molecular interaction assay, which is arranged to measure the presence or concentration of a specific target molecule (which may be referred to as an analyte). A molecular interaction assay typically uses a bio-receptor which can bind to the analyte. Such interactions are extremely specific with the bio-receptor and analyte binding in a similar way to a key and a lock. Typically, only the correct analyte is able to bind to the bio-receptor.

Many such assays require also use a reporter molecule. The reporter molecule is operable to bind to the analyte, typically only once the analyte has bound to the bio-receptor. The reporter molecule can report the presence of the analyte target molecule in some way. For example, the reporter molecule may use: an enzyme, as in an enzyme linked immunosorbent assay (ELISA); radioactivity, as in a radio immunosorbent assay (RIA); or, more commonly, a fluorophore, as in a fluorescent immunosorbent assay (FIA).

As an alternative to the usage of reporter molecules, label-free detection assay methods have been developed and are gaining popularity. One known label-free detection method is surface plasmon resonance (SPR).

One arrangement for using surface plasmon resonance as a label-free detection method (which may be referred to as a surface plasmon resonance apparatus) comprises a prism which is provided with a relatively thin layer of metal (for example gold) on one face thereof. Electromagnetic radiation is coupled into the prism and is incident on the interface between the prism and the metal such that total internal reflection occurs. This generates an evanescent wave in the metal layer which propagates parallel to the interface between the prism and the metal (and in the plane of incidence) and has an amplitude that decays exponentially in a direction perpendicular to the interface between the prism and the metal.

At the interface between the metal layer and an adjacent (dielectric) medium, surface plasmon polaritons can be generated. Surface plasmon polaritons are a type of coupled oscillation of electrons (plasmons) within the metal layer and an electromagnetic oscillation (polaritons) in the dielectric medium. In particular, surface plasmons are collective conduction electron oscillations at the interface of two layers, one layer being a metal (usually a noble metal) and the second layer being a dielectric. If the thickness of the metal layer is sufficiently thin (with respect to a penetration depth of the evanescent wave) and a resonance condition is met, an evanescent wave can excite surface plasmon polaritons on an opposite side of the metal layer to the prism. This uses some of the energy from the incident electromagnetic radiation and therefore reduces the intensity of the electromagnetic radiation reflected from the interface between the prism and the metal layer.

Reflected electromagnetic radiation is coupled out of the prism and is incident on a detector, which is arranged to determine an intensity of the reflected electromagnetic radiation (which, in turn, is dependent on whether or surface plasmon polaritons have been excited).

The resonance condition is dependent on the wavelength and angle of incidence of the incident electromagnetic radiation. The resonance condition is also dependent on optical properties of both the metal and the adjacent (dielectric) medium. If the metal is provided with a bio-receptor on its surface then these optical properties (and therefore the resonance condition) may vary in dependence on the presence or absence of a specific target molecule (or analyte) being bound to the bio-receptor. Therefore, by measuring information related to the resonance condition, it is possible to determine information about the presence and/or quantity of the specific target molecule adjacent the metal layer.

In some systems, a plurality of different bio-receptors are provided on the metal layer; each one is irradiated with electromagnetic radiation and the electromagnetic radiation reflected from each is detected by a separate detector. Such an arrangement is known as imaging SPR (iSPR).

One challenge with the above-described imaging surface plasmon resonance apparatus is that the resonance condition is very narrow and therefore it is important to have adequate control over the wavelength and angle of incidence of the incident electromagnetic radiation. In particular, one of the main design challenges in the above-described imaging surface plasmon resonance apparatus is the optical system. Typically, many lenses are required to project light properly onto the prism and to observe the reflected light on the imaging sensor. Each lens has a specific aligned optical path and focal distance to achieve the best illumination and image quality. In particular, the optics which illuminate the metal layer may be required to do so with a precision of the order of 0.1° in order to operate correctly.

It is an aim of the present disclosure to provide an apparatus for determining the presence or concentration of target molecules that address one or more of problems associated with prior art methods, whether identified above or otherwise.

### SUMMARY

In general, this disclosure proposes to overcome the problems in existing arrangements by providing an apparatus that, in use, excites local surface plasmon resonance (LSPR) in metallic nanoparticles and uses a spectral filter to sample a spectral resonance curve of the LSPR. Multiplexing of multiple signals is provided by providing a plurality of receptor sites, each with a corresponding detector, and a waveguide is arranged to receive the electromagnetic radiation produced by a radiation source, divide the electromagnetic radiation and direct a portion of the electromagnetic radiation to each one of a two dimensional array of receptor sites. This arrangement is advantageous since it provides an apparatus with a very high degree of multiplexing and which is very compact.

According to a first aspect of the present disclosure, there is provided an apparatus for determining the presence or concentration of target molecules, the apparatus comprising: a surface defining a two dimensional array of receptor sites; a waveguide arranged to receive at least a portion of incident electromagnetic radiation, divide the electromagnetic radiation and direct a portion of the electromagnetic radiation to each one of a two dimensional array of receptor sites; a detector comprising a two dimensional array of sensing elements, each sensing element arranged to receive electromagnetic radiation from a different one of the two dimensional array of receptor sites; and a spectral filter provided between the surface and the detector.

Advantageously, the apparatus according to the first aspect of the disclosure provides an apparatus with a very high degree of multiplexing and which is very compact, as now discussed.

One type of prior art apparatus for determining the presence or concentration of target molecules is an imaging surface plasmon resonance apparatus. One type of imaging surface plasmon resonance apparatus comprises a prism upon which a metal layer is disposed to form a plurality of receptor sites. This type of arrangement is arranged to generate excite surface plasmon polaritons on an external surface of the metal layer. When specific molecules bind to the receptors the optical properties of the medium adjacent the external surface of the metal layer are altered. However, such an arrangement has a prism and optics arranged to couple radiation into and out of the prism. Such arrangements are therefore rather bulky and have multiple optical components which must be accurately aligned. In fact, it can be important for the optics to be aligned such that the radiation enters the prism at a specific angle with a very small tolerance of the order of 0.1° in order for the apparatus to work.

Compared to such known systems, the present imaging surface plasmon resonance apparatus disclosed here has the following advantages. First, by providing a spectral filter between the surface and the detector each sensing element of the detector receives electromagnetic radiation from one of the receptor sites having a single wavelength (or at least a narrow range of wavelengths). This allows the present apparatus to use local surface plasmon resonance apparatus, as now discussed. In use, metal nanoparticles are provided on the surface at each of the receptor sites. The nanoparticles are coated with receptors. For example the nanoparticles at each different receptor site may be coated with different receptors.

Local surface plasmon resonance (LSPR) occurs at the interface between the surface of a metallic nanoparticle, nanoshell or nanostructrure and a dielectric. When radiation is incident on a metallic nanoparticle the conduction electrons of the metallic layer can be excited such that they coherently oscillate with high amplitude. The excitation of local surface plasmon resonance is dependent on the wavelength of the radiation. If broadband radiation (for example white light or full spectrum visible light) is incident on the metallic nanoparticle, the scattering efficiency has a maximum, resonance frequency. An absorption spectrum of the metallic nanoparticles (and, for example, the maximum, resonance frequency), is dependent on the optical properties of the (dielectric) medium adjacent the metallic nanoparticles. In turn, the optical properties of the (dielectric) medium adjacent the metallic nanoparticle are dependent on the presence and concentration of specific target molecules that are bound to the receptors coating the metallic nanoparticles. Therefore, by determining information relating to the LSPR absorption spectrum of the metallic nanoparticles the presence and concentration of specific target molecules that are bound to the receptors coating the metallic nanoparticles can be determined.

As the concentration of the specific target molecule (or analyte) that is bound to the receptors at a receptor site varies, the LSPR resonance curve will also vary. For example, upon binding of specific molecules the scattering wavelength of the nanoparticles may shift towards the red end of the spectrum. The spectral filter provided between the surface and the detector effectively samples the resonance spectrum at a fixed wavelength. As the LSPR resonance curve shifts in wavelength the sampled value will increase or decrease.

As used herein, it will be appreciated that a receptor is intended to mean anything (for example a molecule) which can receive and bind to something else. Receptors can comprise any one of a number of biological molecules such as, for example, proteins, viruses and the like.

The apparatus may further comprise a radiation source operable to produce electromagnetic radiation and the incident electromagnetic radiation received by the waveguide may comprise at least a portion of this electromagnetic radiation.

The apparatus may further comprise a radiation source operable to produce electromagnetic radiation and the waveguide may be arranged to receive at least a portion of the electromagnetic radiation produced by the radiation source, divide the electromagnetic radiation and direct a portion of the electromagnetic radiation to each one of the two dimensional array of receptor sites.

In some embodiments the apparatus may comprising a plurality of radiation sources operable to produce electromagnetic radiation and the waveguide may be arranged to receive at least a portion of the electromagnetic radiation produced by each of the plurality of radiation sources.

The radiation source may comprise a broadband radiation source.

For example, a spectrum of the radiation source may have a bandwidth of at least 100 nm. In some embodiments, the radiation source may be operable to produce white light, i.e. radiation across the visible spectrum.

The radiation source may comprise a white light emitting diode.

The apparatus may further comprise a metallic nanostructure disposed on each of the two dimensional array of receptor sites on the surface.

For example, the metallic microstructure may comprise a plurality of nanoparticles.

The nanoparticles may have any desired shape. Possible shapes of the nanoparticles include, for example, spheres, cubes, branches or stars, rods and/or bi-pyramids. The refractive index unit (RIU) for LSPR may be defined as a shift (in nanometers) of the LSPR resonance curve per unit of refractive index of the surrounding (dielectric) medium. The LSPR RIU is dependent on the shape of the nanoparticles. In general, the higher the asymmetry of a nanoparticle, the higher the RIU. In general a higher aspect ratio of a shape (for example a rod or a bi-pyramid) will result in a higher RIU.

In general, it may be desirable for the nanoparticles to have a shape with a relatively large RIU. In general, it may be desirable for the nanoparticles to have a shape which can be consistently manufactured with well controlled, size and aspect ratio.

The metallic nanostructure may comprise any type of metal. The metallic nanostructure may comprise a noble metal. Advantageously, noble metals are less prone to oxidization. For example the metallic nanostructure may comprise gold nanoparticles.

The apparatus may further comprise a receptor provided on each metallic microstructure.

The apparatus may further comprise a printed circuit board and the detector may be mounted on the printed circuit board.

For embodiments that comprise a radiation source, the radiation source and the detector may both be mounted on the printed circuit board.

For example, the radiation source and the detector may be adjacent each other on the printed circuit board.

The waveguide may be disposed between the detector and the surface defining the two dimensional array of receptor sites.

The waveguide may comprise a generally planar body. The surface defining the two dimensional array of receptor sites may be a surface of said body.

The body may be formed from glass. The waveguide may comprise a generally planar body. The body may comprise a plurality of channels formed in said body, each channel arranged to receive a portion of the electromagnetic radiation produced by the radiation source and to direct that portion of the electromagnetic radiation to one of a two dimensional array of receptor sites. The channels may, for example be formed from a material having a larger refractive index than a surrounding portion of the body.

The waveguide may comprise integrated optics. Such integrated optics may be referred to as on-chip technology or on-chip optics.

The waveguide may comprise an integrated optics plate arranged to receive the electromagnetic radiation output by a radiation source at an input and to spread out the electromagnetic radiation over the surface defining the two dimensional array of receptor sites.

The waveguide may comprise one or more diffusors, collimating tubes, pinholes and/or molded lenses.

The waveguide may comprise a plurality of beam splitters or optical waveguide splitters arranged to spread the incident radiation over the surface defining the two dimensional array of receptor sites.

The waveguide may comprise one or more grating structures arranged to produce an interference pattern and spread the radiation over the surface defining the two dimensional array of receptor sites.

The apparatus may further comprise a processor operable to determine a concentration of a target molecule from an intensity of the electromagnetic radiation received from a corresponding one of the two dimensional array of receptor sites.

The detector may comprise any suitable electromagnetic radiation detector. Suitable detectors include, for example, a single-photon avalanche detectors (SPAD), photodiodes, complementary metal-oxide-semiconductor (CMOS) diode arrays and/or charge-coupled device (CCD) arrays.

In some embodiments, the apparatus may comprise one or more polarizer arranged to polarize a portion of radiation. In other embodiments such polarizers may be omitted.

The apparatus may further comprise one or more sensors operable to determine one or more ambient conditions.

For example, the apparatus may comprise sensors operable to determine one or more of: a relative humidity, temperature and/or pressure adjacent the layer of metal.

The apparatus may further comprise a user interface for receiving signals from the detector.

For example the printed circuit board may be provided with a USB port, which may form part of the user interface. For embodiments comprising a radiation source, the user interface may also be suitable for providing signals to the radiation source.

The spectral filter may have a full width at half maximum bandwidth of 10 nm or less.

For example, the spectral filter may have a full width at half maximum bandwidth of 5 nm or less.

The spectral filter may comprise a two dimensional array of individual spectral filters, each individual spectral filter being disposed adjacent a different one of the two dimensional array of sensing elements.

The waveguide may comprise a plurality of waveguide channels formed in a body of the waveguide, each waveguide channel being arranged to direct radiation to a different one of a plurality of discrete positions within the body, each such discrete position being adjacent a different one of the two dimensional array of sensing elements.

Each waveguide channel may be formed from a core material surrounded by a cladding material. The cladding material may confine the radiation to the core material, guiding the radiation.

The waveguide may comprise a plurality of waveguide channels and waveguide splitters.

Each of the waveguide splitters may be arranged to receive a portion of radiation from the radiation source and to divide this electromagnetic radiation and direct a portion of this electromagnetic radiation to each one of two waveguide channels. The waveguide channels and waveguide splitters may be arranged in succession such that the radiation in each one of two waveguide channels which receive radiation from one of the waveguide splitters may in turn be received by another one of the waveguide splitters.

The waveguide may comprise a two dimensional array of coupling optics, each coupling optic arranged to couple radiation out of the waveguide and towards a different one of the two dimensional array of receptor sites.

Each coupling optic may comprise a patterned portion at an end of a waveguide channel within a body of the waveguide.

The patterned portion at the end of a waveguide channel may comprise a plurality of grooves formed on a cladding material of the waveguide channel.

The patterned portion may, for example, be formed on a surface of the cladding material of the waveguide channel that is distal an adjacent one of the two dimensional array of sensing elements and which is proximal one of the two dimensional array of receptor sites. The grooves of the patterned portion may have any desired cross-sectional shape. For example, grooves of the patterned portion may be square or rounded (for example circular) grooves.

Alternatively a different form of patterned portion may be formed on a surface of the cladding material of the waveguide channels. Examples of different patterned portions for coupling radiation out of a waveguide channel include: apertures in the cladding material; thinner portions of the cladding material; a cladding material having a different refractive index (to that of the other sides of the cladding material); or other grooved or patterned structures.

Alternatively, each coupling optic may comprise a mirror or a prism.

Each coupling optic may comprise a microlens array arranged to receive radiation that couples out of a waveguide channel and to direct said radiation as an illumination beam towards one of the two dimensional array of receptor sites.

### BRIEF DESCRIPTION OF THE PREFERRED EMBODIMENTS

Some embodiments of the disclosure will now be described by way of example only and with reference to the accompanying drawings, in which:

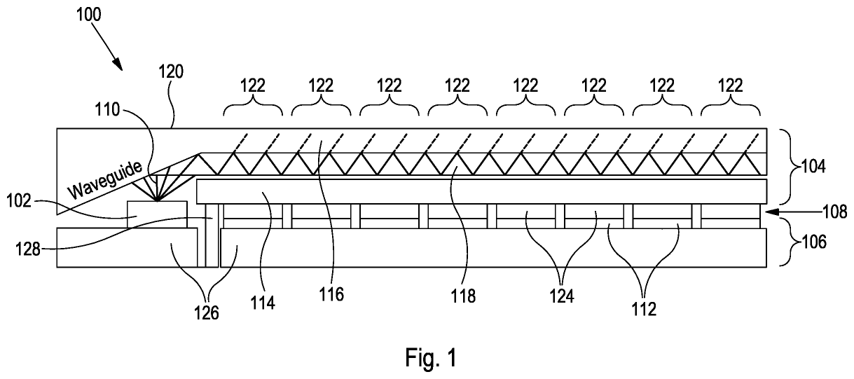

FIG. 1 is a schematic illustration of an apparatus according to the present disclosure;

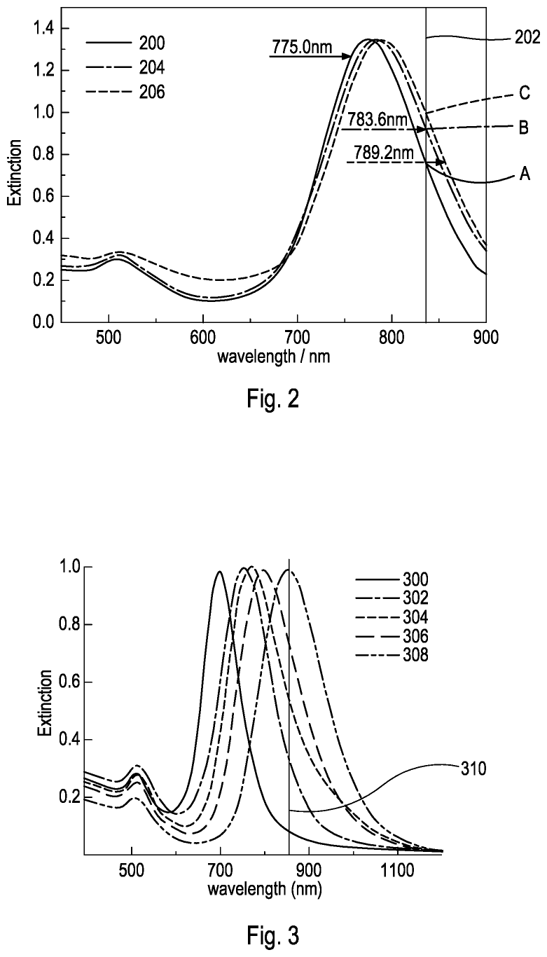

FIG. 2 shows an example local surface plasmon resonance absorption spectrum for gold nanorods;

FIG. 3 shows the local surface plasmon resonance absorption spectra of five differently sized nanoparticles;

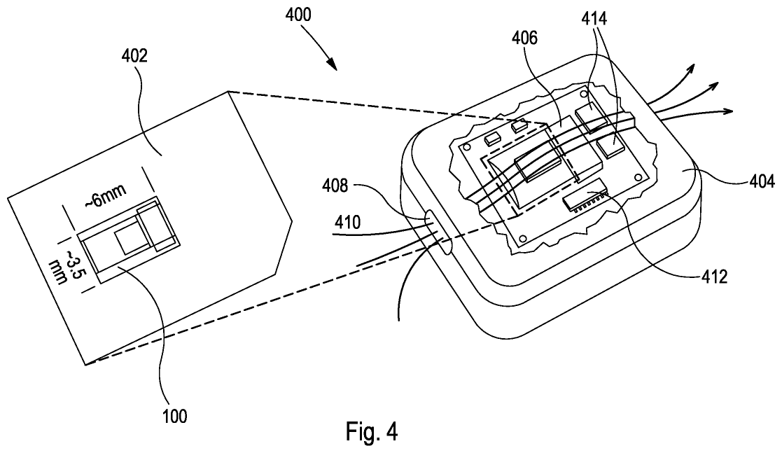

FIG. 4 shows an apparatus which comprises the apparatus shown in FIG. 1;

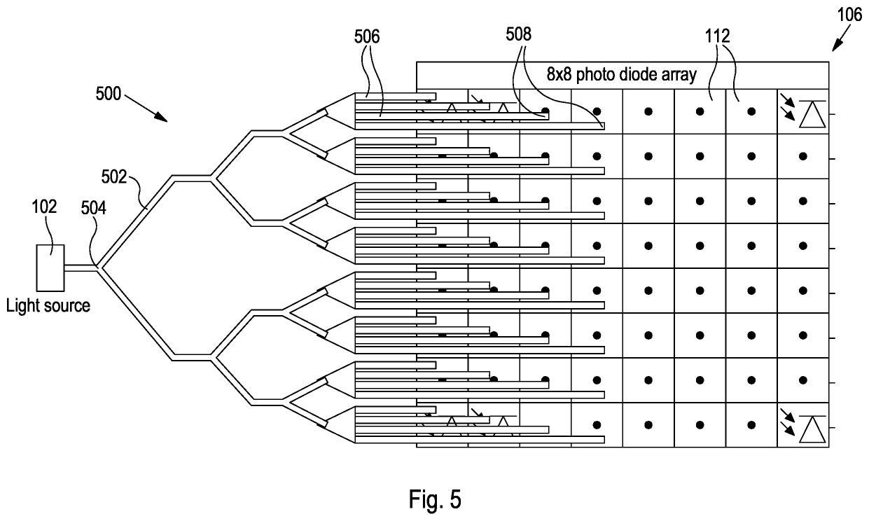

FIG. 5 shows a plan (top) view of a schematic arrangement of waveguide channels that may be formed within the waveguide of the apparatus shown in FIG. 1;

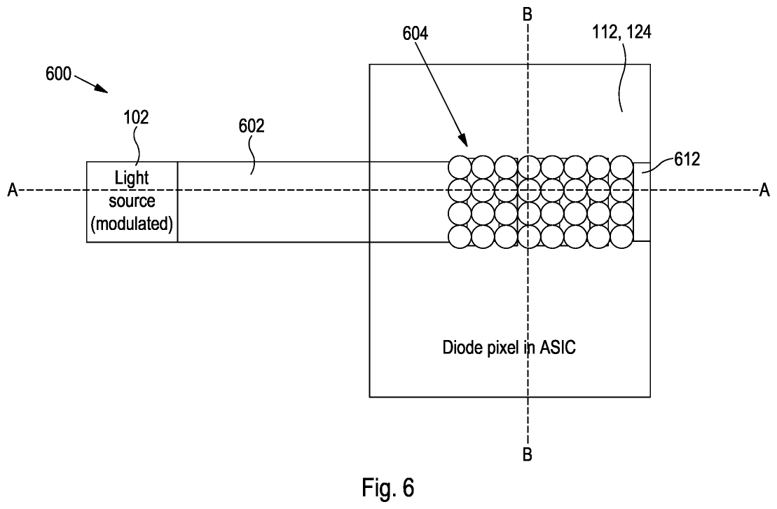

FIG. 6 is a top view of a schematic representation of a portion of a waveguide adjacent to a single sensing element of the detector of the apparatus shown in FIG. 1;

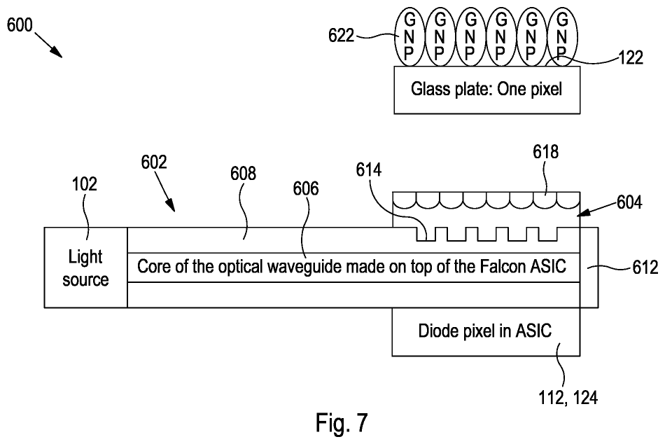

FIG. 7 is a cross sectional view of the schematic representation shown in FIG. 6 through the line A-A; and

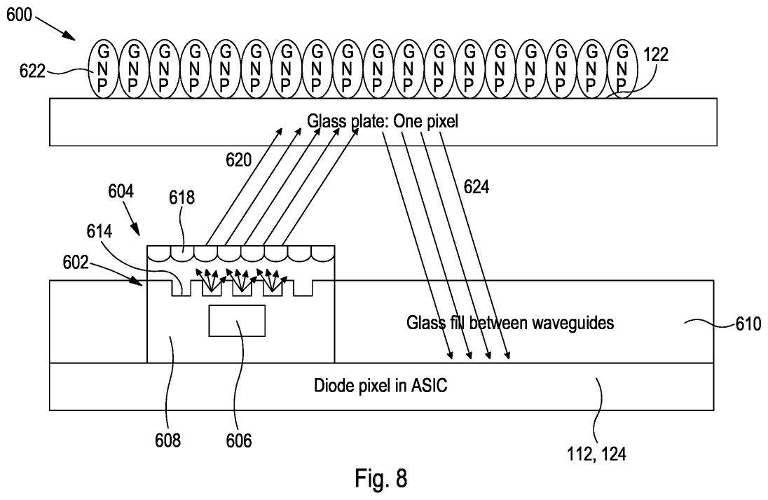

FIG. 8 is a cross sectional view of the schematic representation shown in FIG. 6 through the line B-B.

### DETAILED DESCRIPTION OF THE PREFERRED EMBODIMENTS

Generally speaking, the disclosure proposes an apparatus that, in use, excites local surface plasmon resonance (LSPR) in metallic nanoparticles and uses a spectral filter to sample a spectral resonance curve of the LSPR. The spectral filter may form part of a detector sensing element. Multiplexing of multiple signals is provided by providing a plurality of receptor sites, each with a corresponding detector, and an optical waveguide is arranged to receive the electromagnetic radiation produced by a radiation source, divide the electromagnetic radiation and direct a portion of the electromagnetic radiation to each one of a two dimensional array of receptor sites. This arrangement is advantageous since it provides an apparatus with a very high degree of multiplexing and which is very compact, as now discussed.

Some examples of such an apparatus are shown in the accompanying figures, as now discussed.

FIG. 1 is a schematic illustration of an apparatus 100 according to the present disclosure. The apparatus 100 is suitable for determining the presence or concentration of target molecules. The apparatus 100 comprises: a radiation source 102, a waveguide 104, a detector 106 and a spectral filter 108.

The radiation source 102 is operable to produce electromagnetic radiation 110. In the general radiation source 102 is a broadband radiation source. For example, a spectrum of the radiation source 102 may have a bandwidth of at least 100 nm. In some embodiments, the radiation source may be operable to produce white light, i.e. radiation across the visible spectrum. In one embodiment, the radiation source 102 comprises a white light emitting diode.

The detector 106 comprises a two dimensional array of sensing elements 112. In the embodiment shown in FIG. 1, detector 106 comprises an 8×8 two dimensional array of sensing elements 112. It will be appreciated that only one row of 8 sensing elements 112 is shown in the plane of FIG. 1 but that there are an additional 7 rows of 8 sensing elements 112 in planes parallel to the plane of FIG. 1. It will be appreciated that in other embodiments, there may be fewer than or greater than 64 sensing elements 112.

The detector 106 may comprise any suitable type of electromagnetic radiation detector.

Suitable detectors include, for example, a single-photon avalanche detectors (SPAD), photodiodes, complementary metal-oxide-semiconductor (CMOS) diode arrays and/or charge-coupled device (CCD) arrays. In one embodiment, the detector 106 is an array of photodiodes 112. Alternatively, the detector 106 may comprise an image sensor.

The detector 106 may have any desirable resolution. In one embodiment, the detector 106 comprises 16 bit analogue to digital converters. However, it will be appreciated that in other embodiments the 106 may comprises analogue to digital converters having different resolutions.

The apparatus 100 further comprises a common printed circuit board 126. The radiation source 102 and the detector 108 are both mounted on the printed circuit board 126. In particular, the radiation source 102 and the detector 106 are disposed adjacent each other on the printed circuit board 126. The waveguide 104 is disposed over the radiation source 102 and the detector 106. That is, the the radiation source 102 and the detector 106 are disposed between the printed circuit board 126 and the waveguide 104.

The waveguide 104 comprises a generally planar body. As shown rather schematically in FIG. 1, the waveguide 104 may comprise two generally planar body portions: an adjacent body portion 114 disposed adjacent the detector 106 and a distal body portion 116 which is distal from the detector 106. The adjacent and distal body portions 114, 116 are separated by a central waveguide portion 118.

A surface 120 of the distal body portion 116 defines a two dimensional array of receptor sites 122, as now discussed. Each of the receptor sites 122 comprises a portion of the surface 120 of the distal body portion 116 which is opposite one or the sensing elements 112 of the detector 106. More particularly, each of the receptor sites 122 comprises a portion of the surface 120 of the distal body portion 116 which can emit radiation that can be received by a corresponding sensing element 112 of the detector 106. Therefore, each sensing element 112 of the detector 106 may be considered to be arranged to receive electromagnetic radiation from a different one of the two dimensional array of receptor sites 122.

The waveguide 104 is disposed between the detector 106 and the surface 120 defining the two dimensional array of receptor sites 122.

The spectral filter 108 is provided between the surface 120 of the waveguide 104 and the detector 106. In this embodiment, the spectral filter 108 comprises a plurality of individual spectral filters 124, each one disposed adjacent a different one of the sensing element 112 of the detector 106.

The spectral filter 108 and/or each of the plurality of individual spectral filters 124 may comprise any desired type of filter. Suitable filters include bandpass filter with a relatively narrow bandwidth, for example having a full width at half maximum of 5 to 10 nm. Suitable filters also include interference filters and/or dichroic filters. Generally, the spectral filter 108 and/or each of the plurality of individual spectral filters 124 may have a relatively narrow bandwidth, for example having a full width at half maximum of 5 to 10 nm.

In this embodiment, the spectral filter 108 comprises a plurality of individual spectral filters 124. The plurality of individual spectral filters 124 may sample at different wavelengths or at substantially the same wavelength. Although in this embodiment the spectral filter 108 comprises a plurality of individual spectral filters 124, in alternative embodiments a single filter could be provided over all of the sensing elements 112 of the detector 106.

In addition to the spectral filter 106, each sensing element 112 of the detector 106 may be provided with an angular filter to limit the numerical aperture of each sensing element 112. This may help to ensure that each sensing element only receives radiation scattered from its corresponding receptor site 122.

As shown rather schematically in FIG. 1, the distal body portion 116 of the waveguide extends over both the radiation source 102 and the detector 106 whereas the adjacent body portion 114 of the waveguide 104 only extends over the detector 104. That is the adjacent body portion 114 of the waveguide 104 does not extend over the radiation source 102. Therefore, the radiation 110 emitted by the radiation source can couple into the central waveguide portion 118. In this way, the waveguide 104 is arranged to receive at least a portion of the electromagnetic radiation 110 produced by the radiation source 102.

A barrier 128 is provided between the radiation source 102 and the detector 106. The barrier may prevent any of the radiation 110 emitted by the radiation source 102 from being received directly by the detector 106.

The waveguide 104 is further arranged to divide the electromagnetic radiation 110 that it receives from the radiation source and to direct a portion of this electromagnetic radiation 110 to each one of a two dimensional array of receptor sites 122. As will be appreciated by the skilled person, there are a number of optical arrangements that may allow the waveguide to function in this way, some of which are discussed now.

The body of the waveguide 104 may be formed from glass. For example, the adjacent and distal body portions 114, 116 may be formed from glass. Similarly, the central waveguide portion 118 may be formed from glass.

In some embodiments, the central waveguide portion 118 may comprise a plurality of channels formed in the body of the waveguide 104. Each channel may be arranged to receive a portion of the electromagnetic radiation 110 produced by the radiation source 102 and to direct that portion of the electromagnetic radiation 110 to one of a two dimensional array of receptor sites 122. The channels may, for example be formed from a material having a larger refractive index than a surrounding portion of the body of the waveguide 104.

The waveguide 104 may comprise integrated optics. Such integrated optics may be referred to as on-chip technology or on-chip optics.

In some embodiments, the waveguide 104 may comprise an integrated optics plate arranged to receive the electromagnetic radiation 110 output by the radiation source 102 at an input and to spread out the electromagnetic radiation over the surface 120 defining the two dimensional array of receptor sites 122.

The waveguide 104 may comprise one or more diffusors, collimating tubes, pinholes and/or molded lenses.

In some embodiments, the waveguide 104 may comprise a plurality of beam splitters or optical waveguide splitters arranged to spread the radiation over the surface 120 defining the two dimensional array of receptor sites 122.

In some embodiments, the waveguide 104 may comprise one or more grating structures arranged to produce an interference pattern and spread the radiation over the surface 120 defining the two dimensional array of receptor sites 122.

The waveguide 104 is an asymmetrically light leaking waveguide. In particular, the radiation 110 within the waveguide 104 leaks through the distal body portion 116 (as indicated by dotted lines). However, the radiation 110 within the waveguide 104 does not leak through the adjacent body portion 114. The radiation 110 within the waveguide 104 leaks through the distal body portion 116 at a plurality of discrete positions, each such discrete position being adjacent to one of the receptor sites 122. Since radiation 110 leaks through, or is coupled out of, the distal body portion 116 of the waveguide at these discrete positions, the receptor sites 122 can be illuminated from the waveguide.

It will be appreciated that the electromagnetic radiation can be coupled out of the waveguide 104 adjacent each of the receptor sites 122 in various different ways. For example, the radiation 110 within the waveguide 104 may be coupled out through the distal body portion 116 at each of the plurality of discrete positions using mirrors, prisms and/or patterns in a cladding material of the waveguide 104. For example, patterns in a cladding material of the waveguide 104 may include providing on a side of the waveguide 104 that is closest to the receptor sites 122: apertures or thinner portions of the cladding material, a different refractive index material (to that of the other sides of the waveguide) or grooved structures.

As discussed further below, in use nanoparticles functionalized by a receptor are provided at the receptor sites 122. The waveguide 104 allows these nanoparticles functionalized by receptors to be illuminated from the side, which can excite local surface plasmon resonance. This results in scattering of the radiation, which can be measured by the detector 106. Since the radiation 110 within the waveguide 104 does not leak through the adjacent body portion 114, the radiation 110 emitted by the radiation source cannot directly illuminate the detector 106. This is advantageous since such direct illumination of the detector 106 by the radiation source 102 would provide a background to the LSPR measurement.

Advantageously, the apparatus 100 allows the surface and the receptor sites 122 to be illuminates whilst having the radiation source 102 in the same PCB layer as the detector 106.

Generally speaking, in use, the apparatus 100 excites local surface plasmon resonance (LSPR) in metallic nanoparticles and uses the spectral filter 108 in combination with the detector 106 to sample a spectral resonance curve of the LSPR. Multiplexing of multiple signals is provided by providing a plurality of receptor sites 122, each with a corresponding sensing element 112. This arrangement is advantageous since it provides an apparatus with a very high degree of multiplexing and which is very compact, as now discussed.

In use, a metallic nanostructure is disposed on each of the two dimensional array of receptor sites 122 on the surface 120 of the waveguide. For example, the metallic microstructure may comprise a plurality of nanoparticles.

The nanoparticles may have any desired shape. Possible shapes of the nanoparticles include, for example, spheres, cubes, branches or stars, rods and/or bi-pyramids. The refractive index unit (RIU) for LSPR may be defined as a shift (in nanometers) of the LSPR resonance curve per unit of refractive index of the surrounding (dielectric) medium. The LSPR RIU is dependent on the shape of the nanoparticles. In general, the higher the asymmetry of a nanoparticle, the higher the RIU. In general a higher aspect ratio of a shape (for example a rod or a bi-pyramid) will result in a higher RIU.

In general, it may be desirable for the nanoparticles to have a shape with a relatively large RIU. In general, it may be desirable for the nanoparticles to have a shape which can be consistently manufactured with well controlled, size and aspect ratio.

As an alternative to depositing nanoparticles on the surface 120, in other embodiments, nanolithography may be used to form nanostructures, for example formed from gold, the surface 120.

The metallic nanostructure may comprise a noble metal. For example the metallic nanostructure may comprise gold nanoparticles.

Each metallic nanostructure is coated with receptors. For example, nanoparticles at each different receptor site 122 may be coated with different receptors.

Local surface plasmon resonance (LSPR) occurs at the interface between the surface of a metallic nanoparticle, nanoshell or nanostructrure and a dielectric. When radiation is incident on a metallic nanoparticle the conduction electrons of the metallic layer can be excited such that they coherently oscillate with high amplitude. The excitation of local surface plasmon resonance is dependent on the wavelength of the radiation. If broadband radiation (for example white light or full spectrum visible light) is incident on the metallic nanoparticle, the scattering efficiency has a maximum, resonance frequency.

An absorption spectrum of the metallic nanoparticles (and, for example, the maximum, resonance frequency), is dependent on the optical properties of the (dielectric) medium adjacent the metallic nanoparticles. In turn, the optical properties of the (dielectric) medium adjacent the metallic nanoparticle are dependent on the presence and concentration of specific target molecules that are bound to the receptors coating the metallic nanoparticles. Therefore, by determining information relating to the LSPR absorption spectrum of the metallic nanoparticles the presence and concentration of specific target molecules that are bound to the receptors coating the metallic nanoparticles can be determined.

As the concentration of the specific target molecule (or analyte) that is bound to the receptors at a receptor site varies, the LSPR resonance curve will also vary. In general the LSPR resonance curve is dependent on the net refractive index in the direct vicinity around the nanoparticles. Air generally has a refractive index of 1, whereas odor molecules typically have a refractive index of around 1.45. The nanoparticles are functionalized with receptors so they will selectively allow binding/interaction of odor molecules. Therefore, upon binding of specific molecules the scattering wavelength of the nanoparticles may shift, for example towards the red end of the spectrum. The spectral filter 108 provided between the surface 120 and the detector 106 effectively samples the resonance spectrum at a fixed wavelength. As the LSPR resonance curve shifts in wavelength the sampled value will increase or decrease.

FIG. 2 shows an example LSPR absorption spectrum 200 for gold nanorods, having a maximum, resonance wavelength of 775 nm. A 840 nm spectral filter having a full width at half maximum (FWHM) of 5 nm is represented by a line 202. If the absorption spectrum 200 were measured (for example using one of the sensing elements 112 of the detector 106) using such a spectral filter 108, the observed scattering efficiency would be approximately 0.5 of the peak value.

FIG. 2 also shows an example LSPR absorption spectrum 204 for gold nanorods that have been functionalized with a receptor. Once functionalized with a receptor the extinction peak shifts to 783.6 nm. The observed scattering intensity as sampled by the filter increases. FIG. 2 also shows an example LSPR absorption spectrum 206 for gold nanorods that have been functionalized with the receptor and to which a target molecule has been bound. The extinction peak of this spectrum 206 shifts further to 789.2 nm, a total shift of 5.6 nm. The observed scattering intensity also increases further to 0.65. If the resolution of the detector 106 is 16 bit then the observable accuracy of the intensity as it changes is 1.5×10⁻⁵ (when expressed in 0 to 1), per level of intensity.

It is important that the detector 106 only receives the response of nanoparticles that undergo binding or interaction with e.g. odor molecules. For this purpose, the spectral filter 108 (in particular individual spectral filters 124) are provided over the detector 106.

Advantageously, the apparatus 100 according to the first aspect of the disclosure provides an apparatus with a very high degree of multiplexing and which is very compact and which has a number of advantages over existing apparatus, as now discussed.

One type of prior art apparatus for determining the presence or concentration of target molecules is an imaging surface plasmon resonance apparatus. One type of imaging surface plasmon resonance apparatus comprises a prism upon which a metal layer is disposed to form a plurality of receptor sites. This type of arrangement is arranged to generate excite surface plasmon polaritons on an external surface of the metal layer. When specific molecules bind to the receptors the optical properties of the medium adjacent the external surface of the metal layer are altered. However, such an arrangement has a prism and optics arranged to couple radiation into and out of the prism. Such arrangements are therefore rather bulky and have multiple optical components which must be accurately aligned. In fact, it can be important for the optics to be aligned such that the radiation enters the prism at a specific angle with a very small tolerance of the order of 0.1° in order for the apparatus to work. A major problem with such a prism based SPR system is the angle alignment of the prism and both illumination and detector system. With these tight tolerances, mass manufacturing becomes either problematic or very expensive.

Advantageously, the present apparatus 100 which uses scattering nanoparticles eliminates this problem.

Compared to such known systems, the present imaging surface plasmon resonance apparatus disclosed here has the following advantages.

First, no bulky optical system is required having prisms and lenses. In contrast, the waveguide 104 of the present apparatus 100 is flat and compact. In fact, the complete imaging system of the apparatus 100 can be reduced to less than one cubic centimeter volume or even to similar dimensions as to the current camera modules in mobile phones. The radiation source 102 and detector 106 are disposed on the same plane (for example mounted next to each other on the common 126 PCB or even in same package.

Second, the apparatus does not require a gold layer to be applied to optics, for example using physical vapor deposition (PVD). This is advantageous since gold layer PVD is not compatible with complementary metal-oxide-semiconductor (CMOS) technology such that the CMOS array and the gold layer PVD would need to be manufactured in separate locations.

Third, there is no strict alignment requirement or associated risks of prism de-alignment. Hence the system can be build more precisely and may be more reliable, with fewer components and therefore at significantly lower cost.

In general, the LSPR absorption spectrum is dependent on the size and shape of the nanoparticles or nanostructure. Therefore, if for example nanorods are used, if there is some variation in the lengths and/or aspect ratios of the nanorods then this will affect the LSPR absorption spectrum. However, due to the large leading side of the LSPR absorption spectrum (see, for example the LSPR absorption spectrum 200 in FIG. 2) potential variations in size or shape of the nanoparticles will not have a major impact on the system as now discussed with reference to FIG. 3.

In general, as long as the wavelength that an LSPR absorption spectrum is sampled at (for example by the spectral filter 108) remains on one side of the LSPR absorption spectrum (preferably in a region where the LSPR absorption spectrum is fairly linear) for substantially the entire range of positions of the LSPR absorption spectrum as the refractive index adjacent the metallic nanoparticles then it is possible to measure the selective binding of target molecules to the nanoparticles.

FIG. 3 shows the LSPR absorption spectra 300, 302, 304, 306, 308 of five differently sized nanoparticles. The nanorods all have a width (diameter) of 20 nm. FIG. 3 shows: an LSPR absorption spectrum 300 for nanorods having a resonance wavelength of 700 nm; the LSPR absorption spectrum 302 for nanorods having a resonance wavelength of 750 nm; the LSPR absorption spectrum 304 for nanorods having a resonance wavelength of 780 nm; the LSPR absorption spectrum 306 for nanorods having a resonance wavelength of 808 nm; the LSPR absorption spectrum 308 for nanorods having a resonance wavelength of 850 nm. The intensity is measured at a wavelength of ˜850 nm (i.e. this is the wavelength that the spectral filter samples these LSPR absorption spectra 300, 302, 304, 306, 308 at), as indicated by line 310. The apparatus 100 would be able to measure the selective binding of target molecules to the nanorods having resonance wavelengths of 750 nm, 780 nm and 808 nm particles because in each case the curve (see LSPR absorption spectra 302, 304, 306) can shift to the right leading to an increase in the observed intensity. It would also be possible to measure the selective binding of target molecules to the nanorods having a resonance wavelength of 700 nm although the sampling at line 310 is on a part of the LSPR absorption spectrum 300 which is not very linear and therefore it may be more difficult to determine the response correctly. Since the wavelength at which the intensity is measured (˜850 nm) coincides with the peak of the LSPR absorption spectrum 308, it would not be possible to measure the selective binding of target molecules to the nanorods having a resonance wavelength of 850 nm.

It has been found that the method employed by the apparatus 100 is robust for a size variation which results in more than a 50 nm shift in the resonance wavelength. This translates to a ˜20 nm length variation of 20 nm wide gold nanorods. In turn this is equivalent to a robustness of ˜24 to 33% in size variation of the nanoparticles.

In order to obtain a fingerprint it may be desirable to measure multiple receptors simultaneously. The detector 106 is able to measure 64 spot near simultaneously (for example with 16 bit analogue to digital converters). With such an apparatus 100, most of the sensing elements 112 (for example 60 sensing elements 112) can be used for different receptors and the remaining sensing elements (for example 4 sensing elements 112) can be used for background purposes. This may be described as multiplexing.

Because the apparatus 100 will wear and age, due to the receptors used, resulting in loss of sensitivity it is desirable for the apparatus 100 to be easy replaceable. One arrangement that provides this functionality is now described with reference to FIG. 4.

FIG. 4 shows an apparatus 400 which comprises the apparatus 100 shown in FIG. 1 and described above. The apparatus 100, along with functionalized nanostructures provided on the receptor sites 122 is mounted on a removable daughterboard card 402. The removable daughterboard card 402 may be similar to a (micro) secure digital (SD) card. An advantage of the SD-card size form-factor is the number of pins available for performing communications and supplying power to the apparatus 100.

The daughterboard card 402 provides the apparatus 100 with a user interface for providing signals to the radiation source 102 and/or receiving signals from the detector 106.

Advantageously, the apparatus 400 shown in FIG. 4 provides a particularly cost effective design. Advantageously, the micro-card format may fits into wearables. Advantageously, the micro-card is significantly easier to replace (compared, for example, with optics such as a prism).

The apparatus 400 further comprises a housing 404 provided with a port 406 for releasable engagement with the daughterboard card 402. The housing 404 (shown partially cut away in FIG. 4) is provided with apertures 408 to provide a flow channel to allow a flow 410 of fluid (for example gas) through the housing 404 (and past the apparatus 100 provided on the daughterboard card 402).

The apparatus 400 may further comprise a processor 412 operable to determine a concentration of a target molecule from an intensity of the electromagnetic radiation received from a corresponding one of the two dimensional array of receptor sites 122.

The apparatus 400 further comprises one or more sensors 414 operable to determine one or more ambient conditions. For example, the apparatus 400 may comprise sensors operable to determine one or more of: a relative humidity, temperature and/or pressure adjacent the layer of metal. For gas-phase applications, it may be useful to know the relative humidity, temperature and air pressure of the environment as all these variables can affect the odor molecule interaction on the nanoparticle surface. The sensors 414 may be provided in a flow channel or air-duct of the apparatus 400 so as to obtain accurate information regarding binding.

The air sample containing the odor molecules can be forced into the flow channel by a using a pump. Alternatively, the flow 410 of fluid through the housing 404 may be provided by air diffusion. Embodiments using diffusion will be slower to produce a response but, advantageously, eliminating the need for an active element such as a pump reduces the complexity and cost of the apparatus 400.

FIG. 5 shows a plan (top) view of a schematic arrangement 500 of waveguide channels that may be formed within the waveguide 104 of the apparatus 100 shown in FIG. 1. FIG. 5 shows rather schematically the detector 106 comprising an 8×8 two dimensional array of sensing elements 112.

The arrangement 500 comprises a plurality of waveguide channels 502 and waveguide splitters 504. Each of the waveguide splitters 504 is arranged to receive a portion of radiation from the radiation source 102 and to divide this electromagnetic radiation and direct a portion of this electromagnetic radiation to each one of two waveguide channels 502. The waveguide channels 502 and waveguide splitters 504 are arranged in succession such that the radiation in each one of the two waveguide channels 502 which receive radiation from one of the waveguide splitters 504 may in turn be received by another one of the waveguide splitters 504.

In this way, in the example arrangement 500 shown in FIG. 5, the radiation received by a first waveguide splitter 504 is divided between each of two waveguide channels 502. The radiation in these two waveguide channels 502 is then divided by two waveguide splitters 504 between four waveguide channels 502. The radiation in these four waveguide channels 502 is then divided by four waveguide splitters 504 between eight waveguide channels 502. The radiation in these eight waveguide channels 502 is then divided by eight waveguide splitters 504 between sixteen waveguide channels 502. The radiation in these sixteen waveguide channels 502 is then divided by sixteen waveguide splitters 504 between thirty two waveguide channels 502.

These thirty two waveguide channels 502 may be referred to as end waveguides 506. Each such end waveguide 506 is arranged to direct radiation to a different one of a plurality of discrete position 508, each such discrete position 508 being adjacent a different one of the sensing elements 112 of the detector 106. In this way, radiation is directed to a plurality of discrete positions 508 adjacent to half of the sensing elements 112 of the detector 106.

In the arrangement shown in FIG. 5, although not shown, another waveguide may be provided to direct light around the detector 106 to an edge of the detector 106 opposite the radiation source 102. On this opposite side of the detector 106, another arrangement 500 similar to that described above may be used to direct radiation to a plurality of discrete positions 508 adjacent to the other half of the sensing elements 112 of the detector 106.

It will be appreciated that in alternative embodiments, a similar arrangement of waveguide channels 502 and waveguide splitters 504 may be used to split radiation between a different number or arrangement of discrete positions 508 adjacent to sensing elements of the detector 106.

It will be appreciated that each waveguide channel 502 may be formed from a core material surrounded by a cladding material. The cladding material confines the radiation to the core material, guiding the radiation.

In addition to an arrangement 500 of the type shown in FIG. 5 and described above, the waveguide 104 may be provided with a plurality of coupling optics at each one of the plurality of discrete positions 508 that is arranged to couples radiation out of the end waveguides 506, as now discussed with reference to FIGS. 6, 7 and 8.

FIG. 6 is a top view of a schematic representation 600 of a portion of a waveguide 602 adjacent to a single sensing element 112 of the detector 106 (and an associated individual spectral filter 124). FIG. 7 is a cross sectional view of the schematic representation 600 shown in FIG. 6 through the line A-A. FIG. 8 is a cross sectional view of the schematic representation 600 shown in FIG. 6 through the line B-B.

As shown rather schematically in FIGS. 6 and 7 the waveguide 602 is arranged to receive radiation from the radiation source 102 and to direct it to one of a plurality of discrete locations 604 adjacent one of the sensing elements 112 of the detector 106 (and an associated individual spectral filter 124). The waveguide 602 may, for example, be one of the end waveguides 506 shown in FIG. 5 and described above. Similarly the discrete location 604 may correspond to one of the plurality of discrete positions 508 shown in FIG. 5 and described above.

As best shown in FIGS. 7 and 8, the waveguide 602 comprises a core material 606 surrounded by a cladding material 608. The cladding material 608 confines the radiation to the core material 606, guiding the radiation along the waveguide 602. It will be appreciated (see for example the arrangement 500 shown in FIG. 5) that the waveguide 602 may be one of a plurality of waveguides formed in a body 610 (of the waveguide 104 shown in FIG. 1 and described above).

The waveguide 602 extends from the radiation source 102 to the discrete location 604. An opaque wall is provided at an end of the waveguide 602 to prevent the radiation to propagating out of the waveguide 602 and into the body 610.

In the vicinity of the discrete location 604, a surface of the cladding material 608 of the waveguide 602 that is distal the sensing element 112 of the detector 106 is provided with a patterned portion 614. The patterned portion 614 comprises a plurality of grooves in the surface of the cladding material 608 of the waveguide 602 that is distal the sensing element 112 of the detector 106. To aid understanding these grooves of the patterned portion 614 have been shown schematically in both of the cross-sectional views of FIGS. 7 and 8. The grooves of the patterned portion 614 may have any desired cross-sectional shape. For example, grooves of the patterned portion 614 may be square or rounded (for example circular) grooves.

The patterned portion 614 couples the radiation out of the waveguide over a range of angles, as shown schematically in FIG. 8. Adjacent the patterned portion 614 is disposed a microlens array 616. The microlens array 616 may comprise a molded condenser lens array. The microlens array 616 is arranged to collimate the radiation that couples out of the waveguide 602 via the patterned portion 614 and to direct it as an illumination beam 620 towards the receptor site 122 adjacent the sensing element 112 at a desired angle of incidence.

As explained above, the receptor site 122 may be provided with a metallic nanostructure 622 (for example gold nanoparticles) that may be functionalized by a receptor.

The illumination beam 620 excites local surface plasmon resonance (LSPR) in the metallic nanostructure 622, which in turn emits scattered radiation 624. At least part of the scattered radiation 624 is incident on the sensing element 112 of the detector 106 (via the body 610 and the individual spectral filter 124).

It will be appreciated that the schematic representation 600 shown in FIGS. 6, 7 and 8 and described above is only one example of an arrangement for coupling radiation out of a waveguide 602 and directing it to a receptor site 122.

It will be appreciated that the electromagnetic radiation can be coupled out of the waveguide 104 adjacent each of the receptor sites 122 in various different ways. For example, the radiation 110 within the waveguide 104 may be coupled out at each of the plurality of discrete positions 604 using mirrors, prisms and/or patterns in a cladding material of the waveguide 104.

Alternatively a different form of patterned portion 614 may be formed on a surface of the cladding material 608 of the waveguide 602 that is distal the sensing element 112 of the detector 106 is provided with a patterned portion 614. Examples of different patterned portions for coupling radiation out of a waveguide include: apertures in the cladding material 608; thinner portions of the cladding material 608; a cladding material having a different refractive index (to that of the other sides of the cladding material); or other grooved structures.

### LIST OF REFERENCE NUMERALS

100 apparatus
102 radiation source
104 waveguide
106 detector
108 spectral filter
110 electromagnetic radiation
112 sensing elements
114 adjacent body portion
116 distal body portion
118 central waveguide portion
120 surface
122 receptor site
124 individual spectral filter
126 printed circuit board
128 barrier
200 absorption spectrum for gold nanorods
202 spectral filter
204 absorption spectrum for gold nanorods that have been functionalized with a receptor
206 absorption spectrum for gold nanorods that have been functionalized with the receptor and to which a target molecule has been bound
300 absorption spectrum for nanorods having a resonance wavelength of 700 nm
302 absorption spectrum for nanorods having a resonance wavelength of 750 nm
304 absorption spectrum for nanorods having a resonance wavelength of 780 nm
306 absorption spectrum for nanorods having a resonance wavelength of 808 nm
308 absorption spectrum for nanorods having a resonance wavelength of 850 nm
310 spectral filter
400 apparatus
402 daughterboard card
404 housing
406 port
408 apertures
410 flow of fluid
412 processor
414 sensors
500 arrangement of waveguide channels
502 waveguide channels
504 waveguide splitters
506 end waveguides
508 discrete positions
600 schematic representation of apparatus
602 waveguide
604 discrete location
606 core material
608 cladding material
610 body
614 patterned portion
616 microlens array
620 illumination beam
622 metallic nanostructure
624 scattered radiation

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. An apparatus for determining the presence or concentration of target molecules, the apparatus comprising:
a surface defining a two dimensional array of receptor sites;
a waveguide arranged to receive at least a portion of incident electromagnetic radiation, divide the electromagnetic radiation and direct a portion of the electromagnetic radiation to each one of a two dimensional array of receptor sites;
a detector comprising a two dimensional array of sensing elements, each sensing element arranged to receive electromagnetic radiation from a different one of the two dimensional array of receptor sites; and
a spectral filter provided between the surface and the detector.

2. The apparatus of claim 1 further comprising a radiation source operable to produce electromagnetic radiation and wherein the waveguide arranged to receive at least a portion of the electromagnetic radiation produced by the radiation source, divide the electromagnetic radiation and direct a portion of the electromagnetic radiation to each one of the two dimensional array of receptor sites.

3. The apparatus of claim 2 wherein the radiation source is a broadband radiation source.

4. The apparatus of claim 2 wherein the radiation source comprises a white light emitting diode.

5. The apparatus of claim 1 further comprising a metallic nanostructure disposed on each of the two dimensional array of receptor sites on the surface.

6. The apparatus of claim 1 further comprising a receptor provided on each metallic microstructure.

7. The apparatus of claim 1 comprising a printed circuit board and wherein the detector is mounted on the printed circuit board.

8. The apparatus of claim 2 further comprising a printed circuit board and wherein the radiation source and the detector are both mounted on the printed circuit board.

9. The apparatus of claim 1 wherein the waveguide is disposed between the detector and the surface defining the two dimensional array of receptor sites.

10. The apparatus of claim 1 wherein the waveguide comprises generally planar body and wherein the surface defining the two dimensional array of receptor sites is a surface of said body.

11. The apparatus of claim 1 wherein the waveguide comprises an integrated optics plate arranged to receive the electromagnetic radiation output by a radiation source at an input and to spread out the electromagnetic radiation over the surface defining the two dimensional array of receptor sites.

12. The apparatus of claim 1 wherein the waveguide comprises a plurality of beam splitters or optical waveguide splitters arranged to spread the incident radiation over the surface defining the two dimensional array of receptor sites.

13. The apparatus of claim 1 wherein the waveguide comprises one or more grating structures arranged to produce an interference pattern and spread the radiation over the surface defining the two dimensional array of receptor sites.

14. The apparatus of claim 1 further comprising a processor operable to determine a concentration of a target molecule from an intensity of the electromagnetic radiation received from a corresponding one of the two dimensional array of receptor sites.

15. The apparatus of claim 1 further comprising one or more sensors operable to determine one or more ambient conditions.

16. The apparatus of claim 1 further comprising a user interface for receiving signals from the detector.

17. The apparatus of claim 1 wherein the spectral filter has a full width at half maximum bandwidth of 10 nm or less.

18. The apparatus of claim 1 wherein the spectral filter comprises a two dimensional array of individual spectral filters, each individual spectral filter being disposed adjacent a different one of the two dimensional array of sensing elements.

19. The apparatus of claim 1 wherein the waveguide comprises a plurality of waveguide channels formed in a body of the waveguide, each waveguide channel being arranged to direct radiation to a different one of a plurality of discrete positions within the body, each such discrete position being adjacent a different one of the two dimensional array of sensing elements.

20. The apparatus of claim 1 wherein the waveguide comprises a plurality of waveguide channels and waveguide splitters.

21. The apparatus of claim 1 wherein the waveguide comprises a two dimensional array of coupling optics, each coupling optic arranged to couple radiation out of the waveguide and towards a different one of the two dimensional array of receptor sites.

22. The apparatus of claim 21 wherein each coupling optic comprises a patterned portion at an end of a waveguide channel within a body of the waveguide.

23. The apparatus of claim 22 wherein the patterned portion at the end of waveguide channel comprises a plurality of grooves formed on a cladding material of the waveguide channel.

24. The apparatus of claim 21 wherein each coupling optic comprises a mirror or a prism.

25. The apparatus of claim 21 wherein each coupling optic comprises a microlens array arranged to receive radiation that couples out of a waveguide channel and to direct said radiation as an illumination beam towards one of the two dimensional array of receptor sites.
